(19) United States
(12) Patent Application Publication
(10) Pub. No.: US 2006/0064185 A1
(43) Pub. Date: Mar. 23, 2006

(54) Structure of removable storage media player

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/945,930

(22) Filed: Sep. 22, 2004

(51) Int. Cl. G06F 17/00

(52) U.S. Cl. 700/94

(57) ABSTRACT

An improved structure of a removable storage media player. A power source switch, a USB connector, several control buttons, an earphone socket, a microphone, a camera lens, and several connection parts are mounted on the outside of the removable storage media (mobile disk). A central processor, an analog/digital converter, a digital signal processor, and a transmission interface are mounted on the inside of the removable storage media. The removable storage media is connected to a penpoint through the connection part so that the removable storage media can be applied to listen to music and take notes down.

### BACKGROUND OF THE INVENTION

The present invention relates to an improved structure of a removable storage media player, and more particularly to a structure that is suitable to storage media, writing device, or the like.

With the progress of the technology, the removable hard disk for the computer is diminished from a large-typed disk (about 4.5 cm×15 cm×15.5 cm) to a movable thumb disk (about 3 cm×9.5 cm×1.5 cm). Moreover, the current MP3 music is very popular, and some kinds of thumb disks are equipped with the function of displaying MP3 music. Although these movable hard disks can be applied to replace with Walkman, their main function is to listen to music without additional CD or tape. Thus, they have effects that are no more obvious.

Moreover, the conventional pen device is mainly used for writing. A new type of pen device comprises an infrared LED mounted on the end part of the pen device, wherein a button is protrusively mounted on the pen shaft such that the infrared ray for indication can be generated by pushing the button.

Whereas the aforementioned deficiencies of the conventional structures which are needed to be improved, the motive of the present invention is to provide an improved structure of a removable storage media player that can be used for writing and listening to music. Accordingly, the present inventor has been made diligent studies with a quiet mind to design and fabricate an improved structure of a removable storage media player and to provide thereof for the consumer.

### SUMMARY OF THE INVENTION

The main purpose of the present invention is to provide an improved structure of a removable storage media player that can be applied to listen to music and acted as a writing tool at the same time.

Another purpose of the present invention is to provide an improved structure of a removable storage media player, wherein memory capacity of a Read Only Memory (ROM) of the removable storage media can be expanded so as to backup important information, for example, maintenance phone numbers, notes for operation, and use data for emergency, by burning them into the ROM.

It is still another purpose of the present invention to apply an improved structure of a removable storage media player to the entrance guard.

According to the aforementioned purposes of the present invention, removable storage media is provided, wherein a power source switch, a USB connector, several control buttons, an earphone socket, a microphone, a camera lens and several connection parts are mounted on the outside of the removable storage media (mobile disk). A central processor, an analog/digital converter, a digital signal processor, and a transmission interface are mounted on the inside of the removable storage media. The removable storage media is connected to a penpoint through the connection part so that the removable storage media can be applied to listen to music and take notes down. The removable storage media can be coupled with a necklace by way of another connection part to enable user to hang and carry it.

The aforementioned aspects and advantages of the present invention will be readily clarified in the hereafter description of examples of preferred embodiments of the present invention, in reference with the enclosed drawings.

### BRIEF DESCRIPTION OF THE DRAWINGS

FIG. 1 is an outward appearance diagram of a first preferred embodiment of the present invention.

FIG. 2 is a decomposed diagram showing local devices of the first preferred embodiment of the present invention.

FIG. 3 is a process block diagram of the removable storage media player of the present invention.

FIG. 4 is an outward appearance diagram of a second preferred embodiment of the present invention.

### DETAILED DESCRIPTION OF THE PREFERRED EMBODIMENT

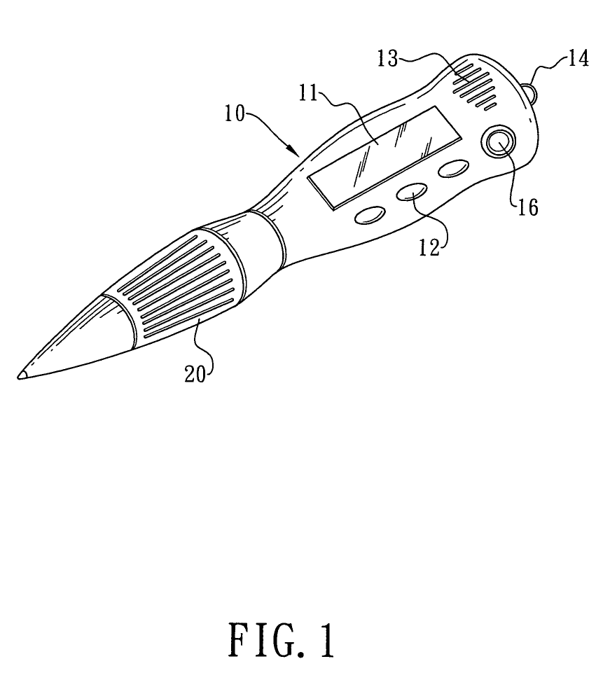

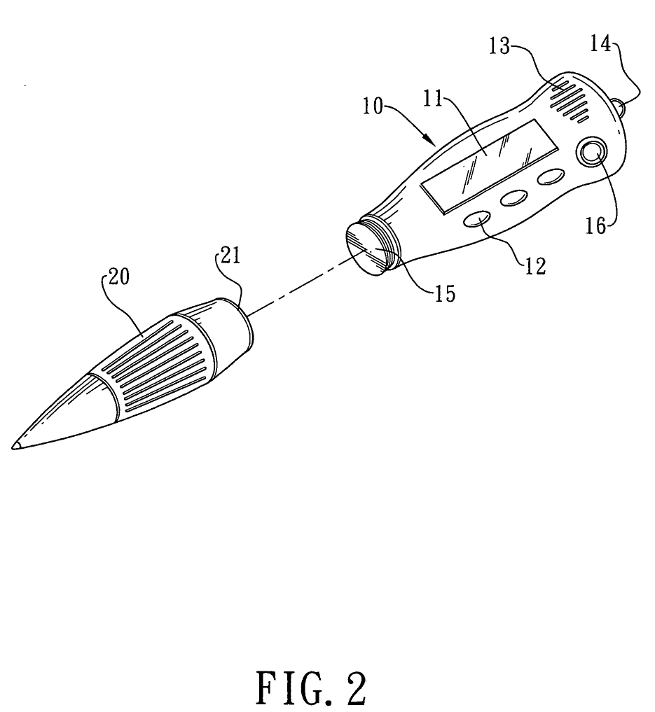

As shown in FIG. 2, an improved structure of a removable storage media player in accordance with the present invention comprises removable storage media 10 and a pen device 20. A LCD monitor 11, several function buttons 12, a microphone 13, a connection ring 14, a locking part 15, a camera lens 16, a USB connector (not shown), an earphone socket (not shown), and a battery chamber (not shown) are mounted on the outside of the removable storage media 10. The pen device 20 is a ballpoint pen with a replaceable cartridge. A locking part 21 is mounted on the top of the pen device 20 for locking up the locking part 15 mounted on the bottom of the removable storage media 10 so as to form the pen device 20 that is easily held by a human hand, as shown in FIG. 1. The removable storage media 10 can be coupled with a necklace by way of the connection ring 14 mounted on the top of the removable storage media 10 to facilitate user to hang and carry it.

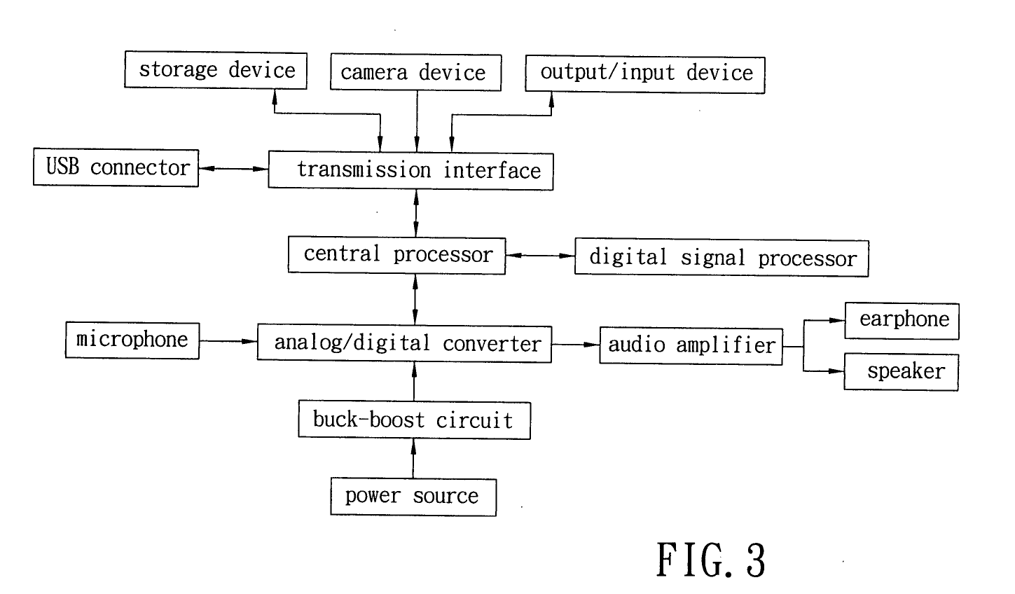

FIG. 3 is a block diagram of internal process. Referring to FIG. 3, the USB connector is connected to a transmission interface, which is bi-directionally connected to the central processor. The transmission interface is also bi-directionally connected to a storage device, a camera device, and an output/input device. The central processor is bi-directionally connected to a digital signal processor and an analog/digital converter. The sound inputted from the microphone is guided to the analog/digital converter and then to the earphone and a speaker through an audio amplifier. The analog/digital converter is connected to a power source through a buck-boost circuit.

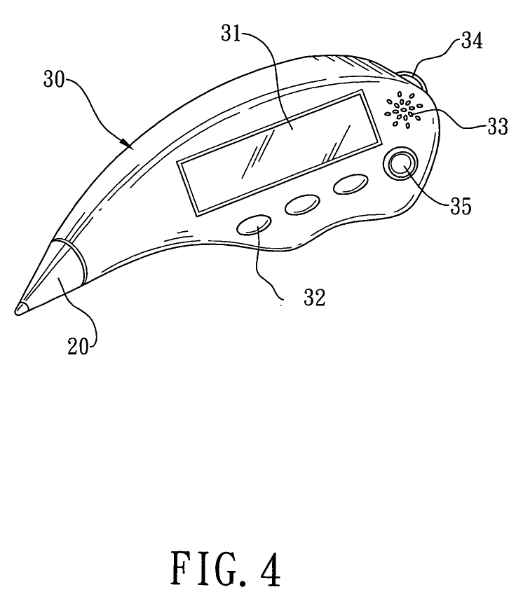

FIG. 4 shows a second preferred embodiment of the present invention. Referring to FIG. 4, the outline of the removable storage media 30 suggests a short-typed pen shaft. A LCD monitor 31, several function buttons 32, a microphone 33, a connection ring 34, a camera lens 35, a USB connector (not shown), an earphone socket (not shown), and a battery chamber (not shown) are mounted on the outside of the removable storage media 30.

The statement's content of the speaker can be recorded on the removable storage media 30 through its recording function while it is applied to a meeting or an important conversation. Thus, by adjusting the displaying speed of the voice file for writing down the record, the voice file can be converted into a text file. Moreover, it can be applied to effectively train the user's speed of taking notes down.

Furthermore, the removable storage media may comprise a built-in Radio Frequency Identification (RFID) System, which is composed of a transponder and a reader. The transponder is a passive answer device. When the system is enabled, the wireless signal with a predetermined frequency will be generated by the reader to active the program embedded in an internal chip of the transponder so as to further generate a radio frequency wave, the ID Code in a memory is transmitted back to the reader and then decoded for differentiation by a master control computer so as to complete the function of identifying the identity. Thus, it is only needed to input data of an individual person or a product into a microchip, and the identifying step can be accomplished by way of the reader. This person or product can pass through entrance guards without carrying various entrance guards' cards.

It is apparent that the apparatus of the present invention comprises the following advantages:

1. The removable storage media can be applied to display music to achieve the purpose of entertainment except writing.

2. The removable storage media comprises the built-in RFID system applied to the entrance guard for identifying the identity. Thus, the user can pass through the entrance gaud without carrying various entrance guards' cards.

3. In the conference, the user is able to use not only the pen device to take notes down but also the sound recording function of the removable storage media to record the conversation of the conference to achieve the full-recording purpose. Moreover, it can be applied to train the user's speed of taking notes down by adjusting the displaying speed.

The foregoing preferred embodiments of the present invention are illustrated of the present invention rather than limiting of the present invention. It is intended that various modifications and similar arrangements be included within the spirit and scope of the appended claims.

As described above, the present invention discloses an innovative and improved structure of a removable storage media

What the invention claimed is:

1. An improved structure of a removable storage media player comprising:
removable storage media, wherein a power source switch, a USB connector, a plurality of control buttons, an earphone socket, a microphone, a camera lens, and a plurality of connection parts are mounted on the outside of the removable storage media, and a central processor, a digital/analog converter, a digital signal processor, and a transmission interface are mounted on the inside of the removable storage media; and
a pen device, wherein a connection part is mounted on one end of the pen device for coupling with one of the plurality of the connection parts of the removable storage media.

2. The improved structure of a removable storage media player of claim 1, wherein the removable storage media comprises a built-in Radio Frequency Identification (RFID) System.

3. An improved structure of a removable storage media player, wherein a power source switch, a USB connector, a plurality of control buttons, an earphone socket, a microphone, a camera lens, a connection part, and a connection hole are mounted on the outside of the removable storage media, and a central processor, a digital/analog converter, a digital signal processor, and a transmission interface are mounted on the inside of the removable storage media, wherein the removable storage media is connected to a penpoint on which a replaceable cartridge is mounted through the connection hole.

4. The improved structure of a removable storage media player of claim 2, wherein the removable storage media comprises a built-in Radio Frequency Identification (RFID) System.
